(19) United States
(12) Patent Application Publication
(10) Pub. No.: US 2023/0394454 A1
(43) Pub. Date: Dec. 7, 2023

(54) UNATTENDED VENDING SYSTEMS AND METHODS OF USING THE SAME

(71) Applicant: PepsiCo, Inc., Purchase, NY (US)

(72) Inventors: Kazim A. KHAN, Nanuet, NY (US); William LYVER, Yonkers, NY (US)

(21) Appl. No.: 17/805,140

(22) Filed: Jun. 2, 2022

(51) Int. Cl. G06Q 20/18; G06Q 20/40; G07F 17/00

(52) U.S. Cl. CPC G06Q 20/18; G06Q 20/40; G07F 17/0064; G07C 9/00896

(57) ABSTRACT

Embodiments described herein relate to mobile vending systems for vending products (e.g., beverages and snacks). The system can be easily repositioned from one position to another and can be operated unattended. The system can include a storage compartment for storing products and a cooling system for maintaining the temperature of the storage compartment. The system can have an integrated system for payment processing, inventory management, and powering the system. The system can detect an authorized user or a payment source to authorize vending of the products. The system can have active cooling systems, passive cooling systems, or both. The active cooling systems can include refrigeration systems for cooling products stored within the system. The passive cooling systems can use temperature control packs for maintaining temperatures within the system.

### BACKGROUND

The present disclosure relates systems and methods for unattended vending of products (e.g., beverages and snacks). Specifically, the present disclosure relates to vending systems that integrate product storage and payment processing, are mobile, and can be operated unattended.

### BRIEF SUMMARY

Some embodiments are directed to a mobile vending system. In some embodiments, the system comprises a storage compartment, a temperature sensor, a cooling system, a user interface, a scanner, a payment processing system, a batter, a power source, and a control unit. In some embodiments, the storage compartment is insulated and configured to store products. In some embodiments, the temperature sensor is disposed within the storage compartment and is configured to detect when the temperature of the storage compartment is greater than a predetermined temperature. In some embodiments, the cooling system is for maintaining the temperature of the storage compartment. In some embodiments, the user interface includes a display. In some embodiments, the scanner is configured to scan the product. In some embodiments, the payment processing system is configured to detect a payment source. In some embodiments, the battery is configured to power the user interface and the payment processing unit. In some embodiments, the power source includes a plug compatible with an electrical outlet. In some embodiments, the power source is configured to power the cooling system and recharge the battery when the plug is inserted into the electrical outlet. In some embodiments, the control unit is configured to communicate with the payment processing unit to authorize a purchase of the product when the payment processing unit detects a payment source and activate the cooling system when the mobile vending system is coupled to a power supply and based on the detection of the temperature sensor. In some embodiments, the mobile vending system is movable from a first position to a second position.

In some embodiments, the mobile vending system includes a housing disposed on an exterior of the mobile vending system. In some embodiments, the housing includes the user interface, scanner, the payment processing unit, and the control unit.

In some embodiments, the mobile vending system further includes a second battery. In some embodiments, the power source is configured to recharge the second battery when the plug is inserted into the electrical outlet. In some embodiments, the battery is configured to power the cooling system when the power source is not inserted into the electrical outlet and when the temperature sensor detects that the temperature of the storage compartment is greater than the predetermined temperature.

In some embodiments, the mobile vending system further includes a photovoltaic panel configured to charge the second battery when the power source is not inserted into the electrical outlet.

In some embodiments, the mobile vending system further includes wheels configured to roll the mobile vending system from a first position to a second position.

In some embodiments, the storage compartment comprises one or more drawers.

In some embodiments, the storage compartment comprises a door for sealing the storage compartment.

In some embodiments, the mobile vending system further includes a lock configured to lock the storage compartment.

In some embodiments, the control unit is configured to unlock the lock when the control unit authorizes the purchase.

In some embodiments, the payment processing unit comprises a camera configured to capture an image of a user.

In some embodiments, the payment processing unit comprises one or more of a credit card reader, a near field communication antenna, and a chip reader.

In some embodiments, the display is a touch-screen display configured to receive a user input.

In some embodiments, the storage compartment comprises a light for illuminating an interior of the storage compartment.

In some embodiments, the storage compartment comprises and inventory management system configured to detect addition or removal of products.

In some embodiments, the inventory management system comprises at least one camera configured to detect when a product is added or removed from the storage compartment.

In some embodiments, the inventory management system comprises weight sensors configured to detect when a product has been removed.

Some embodiments are directed to a mobile vending system comprising a storage compartment, temperature control packs, a user interface, a payment processing unit, a control unit, a battery, and a housing. In some embodiments, the storage compartment is insulated and configured to store pre-chilled products. In some embodiments, the temperature control packs are removably disposed within the storage compartment. In some embodiments, the user interface includes a display. In some embodiments, the payment processing unit is configured to detect a payment source. In some embodiments, the control unit is configured to communicate with the payment processing system to authorize a purchase of the product when the payment processing unit detects a payment source. In some embodiments, the battery is configured to provide power to the user interface, the payment processing unit, and the control unit. In some embodiments, the housing is disposed on an exterior of the mobile vending system. In some embodiments, the housing comprises the user interface, the payment processing unit, and the control unit. In some embodiments, the mobile vending system is movable from a first position to a second position.

In some embodiments, the mobile vending system includes a temperature sensor disposed within the storage compartment, the temperature sensor configured to detect the temperature within the storage compartment.

In some embodiments, the mobile vending system is configured to notify a remote user when the temperature sensor detects that the temperature is above a predetermined threshold for a first period of time.

In some embodiments, the temperature control packs comprise one or more of a freezable gel or ice.

In some embodiments, the mobile vending system further includes a lock configured to lock the storage compartment.

In some embodiments, the control unit is configured to unlock the lock when the control unit authorizes the purchase.

In some embodiments, the control unit is configured to re-lock the lock after a predetermined delay.

In some embodiments, the mobile vending system is configured to provide an audible alert if the storage compartment is open for more than a second period of time.

In some embodiments, the products comprise one or more of a beverage or a food product.

### BRIEF DESCRIPTION OF THE FIGURES

FIG. 1 shows a mobile vending system according to some embodiments.

FIG. 2 shows a mobile vending system according to some embodiments.

FIG. 3 shows a flow chart of a mobile vending system according to some embodiments.

FIG. 4 shows a diagram of electronics systems of mobile vending systems according to some embodiments.

FIG. 5 shows portions of the electronics systems of mobile vending systems according to some embodiments.

FIGS. 6A and 6B show graphical user interfaces on a user interface according to some embodiments.

FIG. 7 shows a method of using mobile vending systems according to some embodiments.

FIG. 8 shows a schematic block diagram of a computer system in which some embodiments can be implemented.

### DETAILED DESCRIPTION

Vending machines are commonly used to dispense products to consumers in an on-demand fashion at various locations, such as grocery stores, convenience stores, shopping malls, sporting or concert venues, gas stations, offices, and movie theaters, among others. Vending machines may be used to dispense any of various types of products, such as food and beverages, or other merchandise, such as toys or electronics. While vending machines may provide consumers with a convenient method for purchasing a product, existing vending machines have a number of drawbacks.

Vending machines generally do not allow a consumer to physically select the specific product to be purchased. Instead, the consumer simply preselects the type of product to be purchased via an interface, and the vending machine dispenses a product of the selected type. As a result, the consumer is unable to physically handle and inspect a product prior to purchasing the product. This may be undesirable when the consumer is not familiar with the product and would benefit from the ability to inspect the product, its packaging, nutritional information, and ingredients. Further, a consumer may prefer to personally select the product to be purchased to ensure that the product is not damaged and to ensure that the desired product is purchased.

Existing vending systems typically have a fixed position, often in an inconvenient location, such as a closet or hallway. Although some vending systems may allow a consumer to physically select the specific product to be purchased, such systems typically have a fixed position and require an attendant or cashier to complete the purchase.

Existing vending machines often require the consumer to enter a code corresponding to the desired product. Taking the time to determine a product code and enter the product code adds a step to the process of purchasing a product and introduces the potential for user error. A consumer may accidentally enter the wrong product code, causing the incorrect product to be dispensed. Similarly, since the consumer cannot physically select and remove the product from the vending machine, there is a risk that the vending machine fails to dispense the selected product, or the dispensed product may be damaged, expired, or otherwise defective. Once dispensed, the consumer is unable to return an incorrect product or a defective product.

Further, vending machines are generally configured to dispense a single product at a time. If a consumer wishes to purchase multiple products, the consumer has to repeat the steps of entering payment, identifying a product code, and entering a product code to dispense the product. This can be time-consuming and inconvenient, and a consumer may prefer to purchase multiple products in a single transaction.

Embodiments described herein overcome these and other challenges by providing—among other benefits—vending systems that are mobile, can operate unattended, and include integrated systems such as temperature controlled systems and payment processing systems. Moreover, embodiments described herein allow for unattended vending machines that can easily be repositioned in close proximity to consumers. For example, systems described herein can be used at parks, hotels, convention centers, offices, concert venues, street fairs, etc. and can be repositioned to maximize access to consumers.

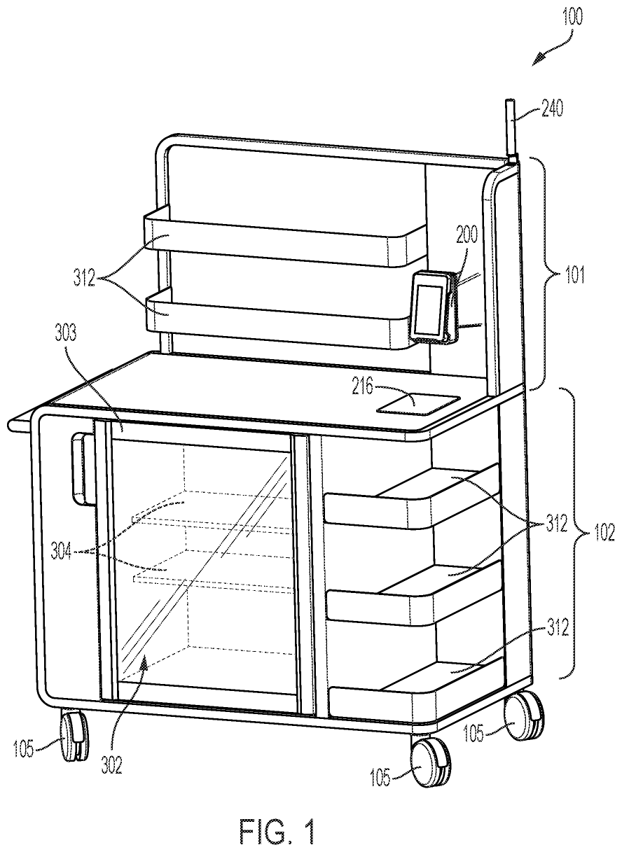

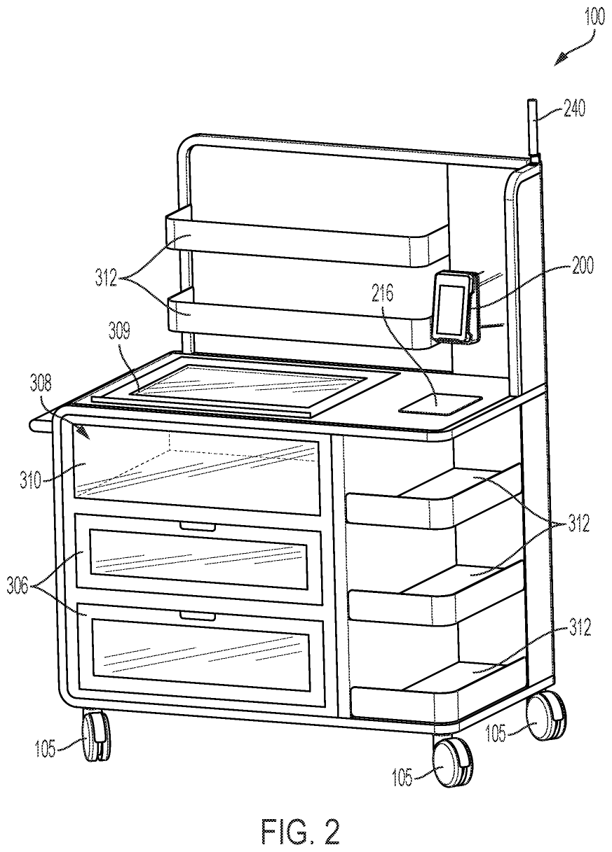

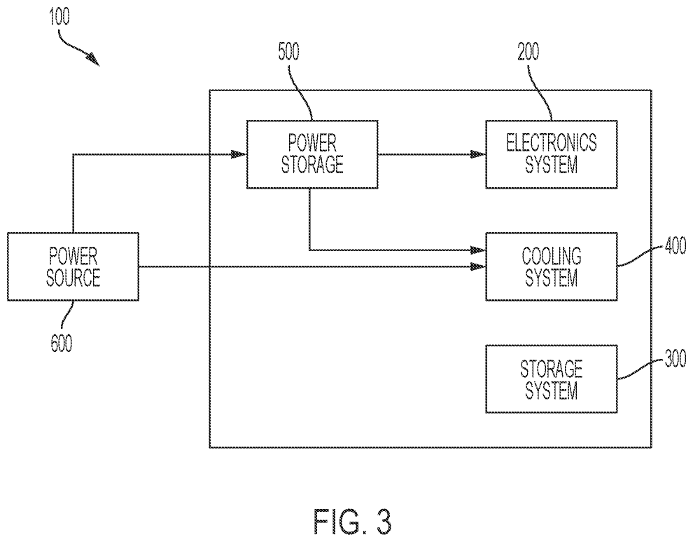

FIGS. 1 and 2 illustrate mobile vending system 100 according to some embodiments. FIG. 3 illustrates a diagram of mobile vending system 100 according to some embodiments. In some embodiments, mobile vending systems 100 includes electronics system 200, storage system 300, cooling system 400, power storage system 500. In some embodiments, mobile vending system 100 includes power source 600 (e.g., plug) configured to removably couple to an electrical outlet (e.g., a 115 V electrical outlet).

In some embodiments, mobile vending system 100 includes storage system 300 for storing products (e.g., snacks or beverages). In some embodiments, storage system 300 can include various storage compartments, for example cabinet 302, drawers 306, recess 308, and/or shelves 312 for storing products. In some embodiments, the storage compartment (e.g., cabinet 302, drawers 306, and/or recess 308) can be insulated. In some embodiments, cabinet 302, drawers 306, and recess 308 can be used for storing chilled products (e.g., beverages such as sodas, juices, coffee, tea, water, etc.). In some embodiments, cabinet 302, drawers 306, and recess 308 can store bottles or cans. In some embodiments, cabinet 302, drawers 306, and/or recess 308 can hold between about 50 to about 125 20-ounce bottles (e.g. about 80 to about 100 20-ounce bottles). In some embodiments, shelves 312 can be used for storing products that can be stored at room temperatures (e.g., snacks such as chips, nuts, etc.).

In some embodiments, as shown in FIG. 1, mobile vending system 100 includes cabinet 302. In some embodiments, cabinet 302 is sealed with door 303. In some embodiments, cabinet 302 includes shelves 304 disposed within cabinet 302. In some embodiments, a consumer can access products stored within cabinet 302 by opening door 303. In some embodiments, door 303 includes a transparent panel (e.g., glass panel, acrylic panel, plexiglass panel, etc.) that allows a consumer to view the products stored within cabinet 302 before opening door 303.

In some embodiments, as shown in FIG. 2, mobile vending system 100 includes drawers 306 and recess 308. In some embodiments, mobile vending system 100 includes 1 or more (e.g., 2 or more, or 3 or more) drawers 306. In some embodiments, each drawer 306 includes a transparent panel (e.g., glass panel, acrylic panel, plexiglass panel, etc.) that allows a consumer to view the products stored within drawer 306 before opening drawer 306. In some embodiments, recess 308 includes a door 309 accessible from a top surface of lower portion 102. In some embodiments, door 309 slides to expose recess 308. In some embodiments, door 309 is hinged and can be opened to expose recess 308. In some embodiments, recess 308 includes transparent panel 310 and door 309 includes a transparent panel. In some embodiments, these transparent panels allow a consumer to view the products stored within recess.

In some embodiments, as shown in FIGS. 1 and 2, mobile vending system 100 includes shelves 312 for storing products. In some embodiments, mobile vending system 100 includes shelves 312 on both the upper portion 101 and lower portion 102. In some embodiments, shelves 312 are used to store products that can be stored at ambient temperature.

In some embodiments, as shown in FIGS. 1 and 2, mobile vending system 100 can include wheels 105. In some embodiments, wheels 105 can be locked to prevent mobile vending system 100 from unintentionally rolling. In some embodiments, wheels 105 allow mobile vending system 100 to be easily repositioned. Mobile vending system 100 could be used at parks, sporting events, conventions, conferences, concerts, etc. Unlike existing vending systems, mobile vending system 100 can simply be moved from one position to another without losing functionality. This is useful for dynamic events where crowds may not be consistently assembled in one location. As one non-limiting example, during a concert it may be desirable to position mobile vending system 100 near other concessions or near the restroom for convenient access near locations where concert goers frequent during a concert. Then near the end of the concert, it may be desirable to move mobile vending system 100 to near the exit of the concert venue or near the parking, near locations where concert goers frequent at the end of a concert. This mobility makes mobile vending system 100 versatile and efficient.

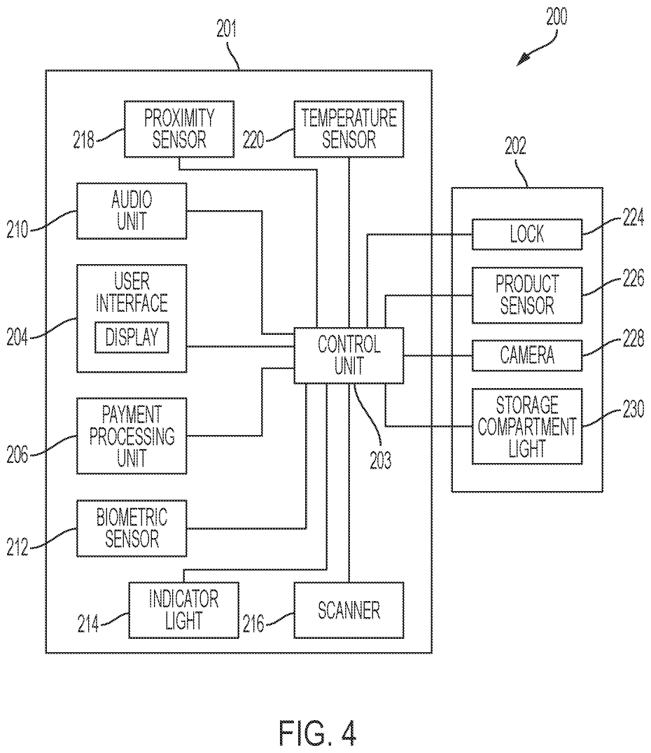

FIG. 4 illustrates a diagram of electronics system 200 according to some embodiments. In some embodiments, electronics system 200 includes first electronics 201 and second electronics 202. In some embodiments, first electronics 201 are used to control the operation of the unit. In some embodiments, first electronics 201 include control unit 203, user interface 204, payment processing unit 206, audio unit 210, sensors (e.g., contactless payment sensor 211, biometric sensor 212, proximity sensor 218, and temperature sensor 220), and scanner 216. In some embodiments, second electronics 202 include lock 224, product sensor 226, camera 228, and storage compartment light 230.

In some embodiments, control unit 203 coordinates operation of mobile vending system 100, as shown in FIG. 4. In some embodiments, a single control unit 203 can control operation of all components of mobile vending system 100. In some embodiments, two or more control units 203 can be used, and each control unit can be used to control different operations or components of mobile vending system 100. For example, a first control unit can control user interface 204 and payment processing unit 206, while a second control unit can control, for example, operation of lock 224, product sensor 226, camera 228, and storage compartment light 230. While it is understood that multiple control units 203 can be used, for convenience, the description herein refers primarily to embodiments having a single control unit 203.

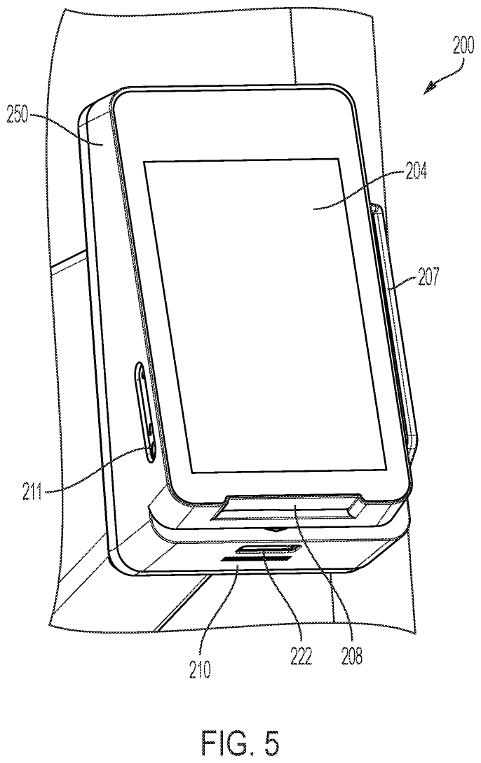

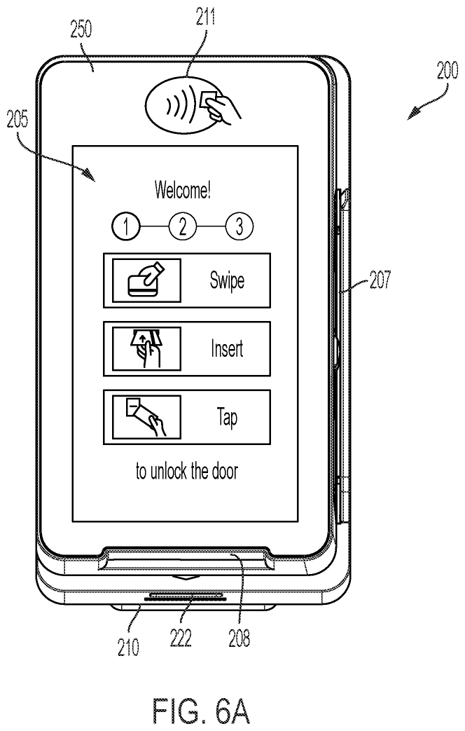

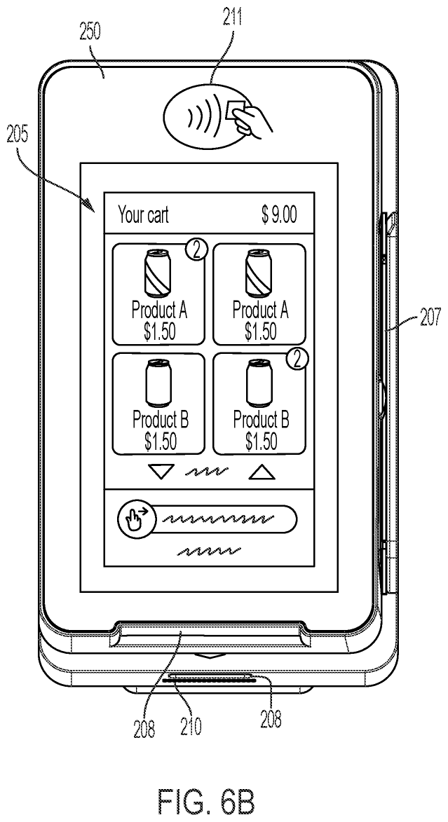

In some embodiments, as illustrated in FIGS. 4-6A, mobile vending system 100 includes user interface 204. In some embodiments, user interface 204 is controlled by control unit 203. In some embodiments, electronics system 200 includes housing 250. In some embodiments, user interface 204 can be arranged on housing 250. In some embodiments, as illustrated in FIGS. 5-6B, user interface 204 is a display. In some embodiments, user interface 204 can show instructions for operating a mobile vending system 100 and my further show product information to a consumer during a product vending operation. In some embodiments, user interface 204 includes a liquid crystal display (LCD), a light emitting diode (LED) display, an organic-LED (OLED) display, among other types of displays. In some embodiments, user interface 204 receives user input. In some embodiments, user interface 204 includes a touch-screen display such that a consumer can touch a portion of the display to enter a user input.

As shown in FIGS. 6A and 6B, user interface 204 can be configured to display a graphical user interface (GUI) 205 for mobile vending system 100. In some embodiments, GUI 205 can provide instructions for operating mobile vending system 100, as shown in FIG. 6A. In some embodiments, GUI 205 can display text, images, or videos that provide information related to mobile vending system 100. For example, in some embodiments, instructions can include text explaining the steps for purchasing a product, as shown in FIG. 6A. In some embodiments, each step includes a corresponding image or animation showing a consumer providing a payment source, a consumer selecting a product, and a consumer completing the purchase. Further, in some embodiments, GUI 205 can show one or more icons for receiving user input, such as an input to confirm a product selection or to complete a purchase of a product. In some embodiments, user interface 204 includes a touch screen, and a consumer can touch a portion of user interface 204 at which an icon is shown in order to enter the user input. In some embodiments, user interface 204 can further include one or more actuators, such as push-buttons, levers, dials, switches, or the life for receiving user input. In some embodiments, user interface 204 includes actuators, and a consumer can utilize actuators to navigate options shown on the display of user interface 204 or to enter a user input.

In some embodiments, electronics system 200 can includes payment processing unit 206 for detecting the presence of a payment source, receiving payment from a consumer, processing the payment, and authorizing purchases of products. In some embodiments, payment processing unit 206 is arranged on housing 250. In some embodiments, payment processing unit 206 includes at least one of magnetic stripe reader 207 for reading a credit card, debit card, ATM card, and the like; chip reader 208 for reading credit cards, debit cards, and other payment cards having electronic chips, i.e., chip cards; a contactless payment sensor 211 (e.g., an near filed communication (NFC) reader) for contactless payments. Payment processing unit 206 can also be configured to receive a mobile payment, such as a payment made using Apple Pay or Google Pay, and can include an RFID sensor configured to read or detect an RFID tag, or a QR code reader configured to scan a QR code or a barcode displayed on a printed membership card, a shopping bag, a bottle, among other items, or a QR code displayed on a mobile device, such as on a software application (or “app”) on the mobile device. Further, payment processing unit 206 can be configured to receive a remote payment or an indication that a consumer has made a payment, such as a payment made on a smartphone or an application on a smartphone, and the indication of remote payment is transmitted to mobile vending system 100 to allow a consumer to purchase a product without entering payment at mobile vending system 100.

In some embodiments, payment processing unit 206 can be used to detect an authorized user. In some embodiments, an authorized user can be determined by entering an identification of a user, such as by entering a user's name wherein the user's name is stored in a database, scanning an identification such as a driver's license or passport, or by entering an identification code. Further, electronics system 200 can include a biometric sensor for determining an identity of a consumer, and, thus, the presence of an authorized user. A consumer's identity can be tied to a payment source, such that upon identification of the consumer, the consumer's payment source can be automatically accessed for purchasing a product. In some embodiments, the biometric sensor can be configured to identify an individual based on a fingerprint, a palm-print, a retina, an iris, a face or facial feature, among other biometrics.

In some embodiments, electronics system 200 can include audio unit 210. In some embodiments, audio unit 210 is configured to emit or produce an audible alert or tone. In some embodiments, audio unit 210 can be arranged on or within housing 250, or can be located external to housing 250 such as on upper portion 101 or lower portion 102 of mobile vending system 100. In some embodiments, audio unit 210 can be in wired or wireless communication with mobile vending system 100. In some embodiments, audio unit 210 can include a memory to store one or more pre-recorded sounds, tones, or messages, among other audible alerts. In some embodiments, audio unit 210 can be configured to play a greeting or welcome to a consumer upon detection of a consumer or upon receipt of a payment source. Further, in some embodiments, audio unit 210 can play a message to thank the consumer upon completion of a purchase. In some embodiments, audio unit 210 can also be configured to produce an alert when a product is removed from or is returned to a product storage compartment of mobile vending system 100, as discussed in further detail below.

In some embodiments, electronics system 200 includes various sensors, such as contactless payment sensor 211 (discussed above); biometric sensor 212 (discussed above); proximity sensor 218; and temperature sensor 220. In some embodiments, mobile vending system 100 includes proximity sensor 218 that is configured to detect when a consumer is within a predetermined distance of mobile vending system 100. In some embodiments, when a consumer is nearby, mobile vending system 100, as determined by proximity sensor 218, user interface 204 can change from a first state to a second state. In some embodiments, the first state is an inactive state in which the user interface 204 is turned off or in a power save mode. In some embodiments, the second state is an active state in which user interface 204 turned on and ready to receive user input. In some embodiments, when a consumer completes a purchase using mobile vending system 100, user interface 204 can change from the second state to the first state.

In some embodiments, mobile vending system 100 includes temperature sensor 220. In some embodiments, temperature sensor 220 is configured to detect the temperature within storage system 300 (e.g., within cabinet 302, drawers 306, and/or recesses 308). In some embodiments, temperature sensor 220 is configured to detect when the temperature within storage system 300 is above or below a predetermined temperature. In some embodiments, control unit 203 is configured to activate cooling system 400 when temperature sensor 220 detects the temperature within the storage system 300 is above a predetermined temperature. In some embodiments, control unit 203 is configured to activate cooling system 400 only when temperature sensor 220 detects the temperature within the storage system 300 is above a predetermined temperature and when power source 600 is coupled to an electrical outlet. In some embodiments, control unit 203 is configured to activate cooling system 400 only when temperature sensor 220 detects the temperature within the storage system 300 is above a predetermined temperature and when either power storage system 500 is charged or when power source 600 is coupled to an electrical outlet.

In some embodiments, mobile vending system 100 includes scanner 216 configured to scan a barcode on a product. In some embodiments, control unit 203 is configured to request payment based on the scanned product. In some embodiments, control unit 203 is configured to display, on user interface 204, information about the scanned product (e.g., price, nutritional information, ingredients).

In some embodiments, electronics system 200 includes a lock (e.g., an electromechanical lock) for maintaining storage system 300 in a closed configuration to prevent unauthorized users from accessing storage system 300 (e.g., cabinet 302, drawers 306, and/or recesses 308) and products therein. In some embodiments, each cabinet 302, drawer 306, and/or recess 308 included in mobile vending system 100 can include a lock in communication with control unit 203. In some embodiments, control unit 203 can control the lock and change the lock between a locked state and an unlocked state. In some embodiments, control unit 203 is configured to unlock the lock in response to the payment processing unit 206 detecting a payment source or an authorize user. In some embodiments, control unit 203 is configured to re-lock the lock after a predetermined delay or after the consumer completes a purchase.

In some embodiments, mobile vending system 100 includes an inventory management system. In some embodiments, inventory management system includes one or more product sensors configured to detect when a product has been removed from, or returned to storage system 300. In some embodiments, product sensor can be an optical sensor, such as a camera (e.g., camera 228), configured to detect and identify a product removed from mobile vending system 100. For example, optical sensor can capture a video of products as they pass by sensor while being removed from or inserted into storage system 300 and can compare the products in the captured video with an image library, such as an edge or cloud-based image library. Alternatively, optical sensors can capture images of products within storage compartment before and after a consumer's purchase to determine which products have been removed. However, various types of sensors can be used to detect removal and return of a product from mobile vending system 100 as will be readily understood by one of ordinary skill in the art. For example, other types of sensors that can be used instead of or in addition to optical sensors include weight sensors to determine a weight of products in storage compartment before and after products are removed, or radio frequency identification (RFID) tags and RFID readers/scanners to detect removal and return of products.

In some embodiments, the product sensor can identify a product by detecting a shape and/or color of a product removed from storage system 300. In some embodiments, the product sensor can be positioned proximate to a front portion of cabinet 302, drawer 306, or recess 308. In some embodiments, the product sensor can define a plane parallel to a front surface of storage system 300 so as to detect when a product passes through the plane, indicating that a product is being removed from or returned to storage system 300.

In some embodiments, electronics system 200 includes storage compartment light 230 configured to illuminate the interior of cabinet 302, drawer 306, and/or recess 308. In some embodiments, control unit 203 is configured to activate storage compartment light in response to the payment processing unit 206 detecting a payment source. In some embodiments, control unit 203 is configured to activate storage compartment light in response to proximity sensor 218 detecting that a consumer is within a predetermined distance of mobile vending system 100. In some embodiments, control unit 203 is configured to activate storage compartment light in response to payment processing unit 206 detecting a payment source or an authorized user.

In some embodiments, cooling system 400 is configured to cool an interior of storage system 300 to a temperature sufficient for chilling products (e.g., beverages). In some embodiments, cooling system 400 is configured to cool an interior of storage system 300 to a temperature less than 5° C. (e.g., less than 4° C., less than 3° C.). In some embodiments, mobile vending system 100 includes cooling system 400 that includes active cooling. In embodiments with active cooling, cooling system 400 can include a refrigeration system for cooling cabinet 302, drawers 306, and/or recess 308. In some embodiments, the refrigeration system is activated by control unit 203 when temperature sensor 220 detects that the temperature in the cabinet 302, drawer 306, and/or recess 308 exceeds a predetermined threshold. In some embodiments, the refrigeration system can be activated only when power source 600 is coupled to an electrical outlet. In some embodiments, refrigeration system can be activated when power source 600 is coupled to an electrical outlet and power source 600 is not coupled to an electrical outlet. In embodiments with active cooling, products (e.g., beverages) can be added to mobile vending system 100 without pre-chilling the products.

In some embodiments, cooling system 400 includes passive cooling. In embodiments with passive cooling, cooling system 400 can include one or more temperature control packs. In some embodiments, the temperature control packs are removable from mobile vending system 100. In some embodiments, the temperature control packs are freezable packs that can be used to chill cabinet 302, drawer 306, and recess 308. In some embodiments, temperature control packs include one or more of a freezable gel and water. In some embodiments, mobile vending system 100 can be used by freezing temperature control packs and pre-chilling products (e.g. beverages) and placing both in cabinet 302, drawer 306, and/or recess 308 for vending.

In some embodiments, mobile vending system 100 includes both active cooling and passive cooling. For example, in embodiments with both active cooling and passive cooling, mobile vending system 100 can include temperature controlled packs that are chilled by the refrigeration system when the refrigeration system is activated.

In some embodiments, mobile vending system 100 can include power storage system 500. In some embodiments, power storage system 500 includes 1 or more (e.g., 2 or more or 3 or more) rechargeable batteries. In some embodiments, power storage system 500 includes one battery configured to power electronics system 200 when power source 600 is not coupled to an electrical outlet. In some embodiments, power storage system 500 includes a first battery configured to power electronics system 200 when power source 600 is not coupled to an electrical outlet and a second battery configured to power cooling system 400 power source 600 is not coupled to an electrical outlet. In some embodiments, power source 600 includes a plug configured to couple to an electrical outlet. In some embodiments, power source 600 recharges the batteries when power source 600 is coupled to an electrical outlet. In some embodiments, mobile vending system 100 can operate for at least 6 hours (e.g., at least 8 hours or at least 12 hours) between charges. In some embodiments, power source 600 is a plug compatible with an electrical outlet. In some embodiments, mobile vending system 100 further includes a photovoltaic panel configured to charge the batteries.

In some embodiments, mobile vending system 100 includes a wireless transceiver (e.g., antenna 240) for communication with a remote user. In some embodiments, the wireless transceiver is configured to alert a remote user regarding the status of mobile vending system 100. In some embodiments, the wireless transceiver can be used to communicate to a remote user that the remaining power in the power storage system 500 is below a predetermined threshold. In some embodiments, the wireless transceiver can be used to communicate to a remote user that the inventory of products remaining in mobile vending system 100 is less than a predetermined amount.

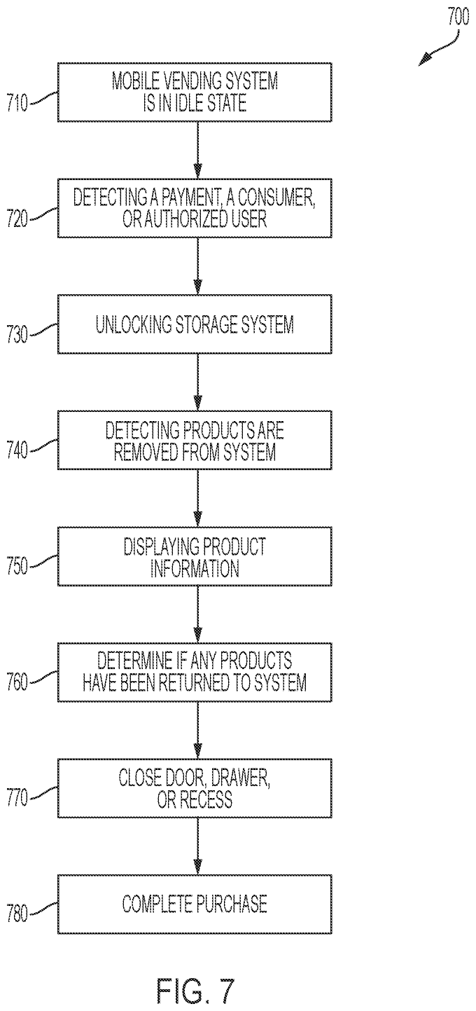

FIG. 7 illustrates a method 700 for using mobile vending system 100 according to some embodiments. In some embodiments, at step 710, when not in use, mobile vending system 100 is in an idle state, with storage system 300 locked. In some embodiments, at step 720, a mobile vending system 100 unlocks storage system 300 based on detecting that a consumer is nearby, detecting a payment source, or detecting the presence of an authorized user. For example, an authorized user can be detected when payment processing unit 206 detects a payment source, such as when a consumer swipes a credit card in a credit card reader of the handle, taps a credit card or mobile payment for contactless payment, or enters a chip of a credit card into a chip reader of the handle. Alternatively, an authorized user can be detected by a biometric sensor of the handle, or when handle receives an indication that a remote payment has been made by a user, such as payment through a software application on a mobile device.

In some embodiments, once an authorized user is detected, at step 730, the cabinet 302, drawer 306, or recess 308 is unlocked, and the consumer can open the door to select a product from the cabinet for purchase. The consumer can remove one or more products from cabinet and, in some embodiments, at step 740, product sensors, such as one or more cameras, within cabinet detect the number of products removed and the type of products removed. In some embodiments, at step 750, product information can be displayed relating to the product(s) removed from the cabinet. User interface 204 can display the product information, such as the number, type, product price, and a total price of the products removed. In some embodiments, at step 760, product sensor of cabinet can determine whether a removed product is subsequently returned to cabinet. For example, a consumer can remove a product from a cabinet and view the product information display to determine the price of the product. If the price is not agreeable to the consumer, the consumer can return the product to the cabinet. Alternatively, a consumer can wish to remove two different products from the cabinet to inspect the products, such as to compare nutrition information or ingredients, and the consumer can opt to return one of the products and purchase the preferred product.

In some embodiments, at step 770, when the consumer is finished selecting products, storage system 300 is closed. In some embodiments, product information relating to the removed products can be displayed on user interface 204. Product information can include the brand of the product, the type or name of the product, the price of the product, and the total price of the removed products. If desired, consumer can reopen the door to continue selecting products. In some embodiments, at step 780, the consumer can complete the purchase of the removed products. To confirm and complete the purchase, the payment source can be required to be detected, such as by swiping or inserting a credit card a second time. Alternatively, display can show a graphic user interface that prompts a consumer to perform a gesture on the display, such as swiping from left to right to confirm the purchase. In some embodiments, once door is closed, purchase can be automatically completed after a predetermined amount of time elapses (e.g., 10 seconds). Once a consumer confirms the purchase, the payment source is charged for the total price of products removed (or an account is credited for the purchase price), and the door of the cabinet locks to secure the products within the cabinet. As a consumer is required to enter a payment source to unlock door of cabinet, the consumer can be charged for any products removed, and products cannot be removed without payment. Further, as consumer's payment source is entered, the consumer is incentivized to ensure that door of cabinet is closed and locked upon completion of the purchase to avoid further charges.

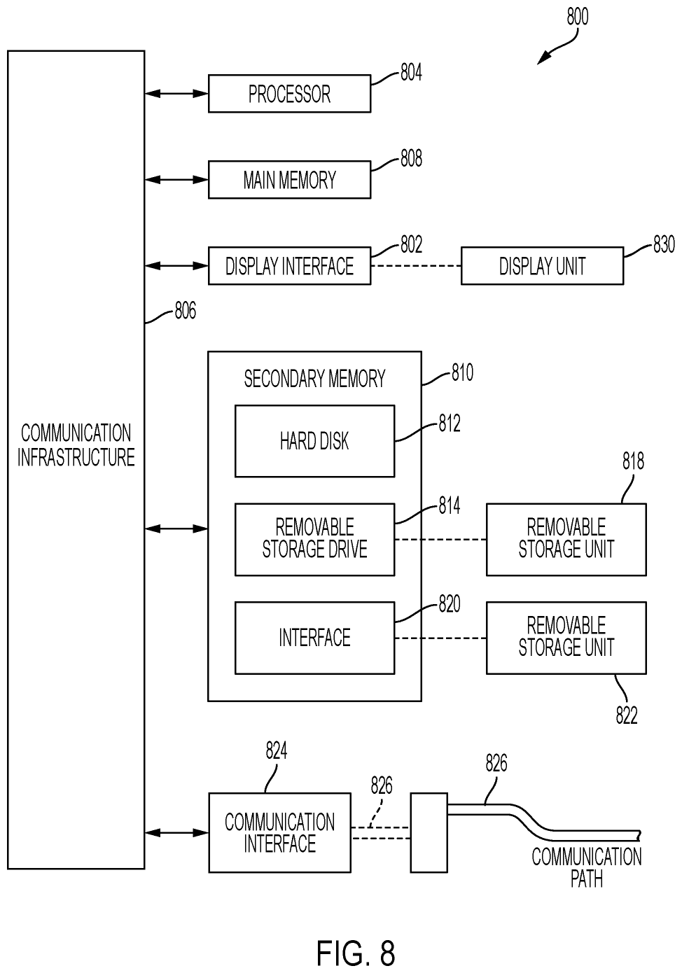

FIG. 8 illustrates a computer system 800 in which embodiments, or portions thereof, can be implemented as computer-readable code. Control unit 203 as discussed herein can be computer systems having all or some of the components of computer system 800 for implementing processes discussed herein.

If programmable logic is used, such logic can execute on a commercially available processing platform or a special purpose device. One of ordinary skill in the art can appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that can be embedded into virtually any device.

For instance, at least one processor device and a memory can be used to implement the above described embodiments. A processor device can be a single processor, a plurality of processors, or combinations thereof. Processor devices can have one or more processor “cores.”

Embodiments described herein can be implemented in terms of this example computer system 800. After reading this description, it will become apparent to a person skilled in the relevant art how to implement embodiments described herein using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 804 can be a special purpose or a general purpose processor device. As will be appreciated by persons skilled in the relevant art, processor device 804 can also be a single processor in a multi-core/multiprocessor system, such system operating alone, or in a cluster of computing devices operating in a cluster or server farm. Processor device 804 is connected to a communication infrastructure 806, for example, a bus, message queue, network, or multi-core message-passing scheme.

Computer system 800 also includes a main memory 808, for example, random access memory (RAM), and can also include a secondary memory 810. Secondary memory 810 can include, for example, a hard disk drive 812, or removable storage drive 814. Removable storage drive 814 can include a floppy disk drive, a magnetic tape drive, an optical disk drive, a flash memory, or the like. The removable storage drive 814 reads from and/or writes to a removable storage unit 818 in a well-known manner. Removable storage unit 818 can include a floppy disk, magnetic tape, optical disk, a universal serial bus (USB) drive, etc. which is read by and written to by removable storage drive 814. As will be appreciated by persons skilled in the relevant art, removable storage unit 818 includes a computer usable storage medium having stored therein computer software and/or data.

Computer system 800 (optionally) includes a display interface 802 (which can include input and output devices such as keyboards, mice, etc.) that forwards graphics, text, and other data from communication infrastructure 806 (or from a frame buffer not shown) for display on display unit 830.

In alternative implementations, secondary memory 810 can include other similar means for allowing computer programs or other instructions to be loaded into computer system 800. Such means can include, for example, a removable storage unit 822 and an interface 820. Examples of such means can include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 can also include a communication interface 824. Communication interface 824 allows software and data to be transferred between computer system 800 and external devices. Communication interface 824 can include a modem, a network interface (such as an Ethernet card), a communication port, a PCMCIA slot and card, or the like. Software and data transferred via communication interface 824 can be in the form of signals, which can be electronic, electromagnetic, optical, or other signals capable of being received by communication interface 824. These signals can be provided to communication interface 824 via a communication path 826. Communication path 826 carries signals and can be implemented using wire or cable, fiber optics, a phone line, a cellular phone link, an RF link or other communication channels.

As used herein, the terms “computer program medium” and “computer usable medium” are used to generally refer to media such as removable storage unit 818, removable storage unit 822, and a hard disk installed in hard disk drive 812. Computer program medium and computer usable medium can also refer to memories, such as main memory 808 and secondary memory 810, which can be memory semiconductors (e.g., DRAMs, etc.).

Computer programs (also called computer control logic) are stored in main memory 808 and/or secondary memory 810. Computer programs can also be received via communication interface 824. Such computer programs, when executed, enable computer system 800 to implement the embodiments as discussed herein. In particular, the computer programs, when executed, enable processor device 804 to implement the processes of the embodiments discussed here. Accordingly, such computer programs represent controllers of the computer system 800. Where the embodiments are implemented using software, the software can be stored in a computer program product and loaded into computer system 800 using removable storage drive 814, interface 820, and hard disk drive 812, or communication interface 824.

Embodiments described herein be directed to computer program products comprising software stored on any computer useable medium. Such software, when executed in one or more data processing device, causes a data processing device(s) to operate as described herein. Embodiments described herein can employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

As used herein, the terms “upper,” “lower,” “top,” “left,” and “right,” and the like are intended to assist in understanding of embodiments of the disclosure with reference to the accompanying drawings with respect to the orientation of components of mobile vending system 100 as shown, and are not intended to be limiting to the scope of the disclosure or to limit the disclosure scope to the embodiments depicted in the Figures. The directional terms are used for convenience of description and it is understood that components of mobile vending system 100 can be positioned in any of various orientations.

As used herein, when the term “about” is used in describing a value or an end-point of a range, the disclosure should be understood to include the specific value or end-point referred to. As used herein, the term “about” can include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

What is claimed is:

1. A mobile vending system, the system comprising:
a storage compartment configured to store products, the storage compartment being insulated;
a temperature sensor disposed within the storage compartment, the temperature sensor configured to detect when the temperature of the storage compartment is greater than a predetermined temperature;
a cooling system for maintaining the temperature of the storage compartment;
a user interface, the user interface comprising a display;
a scanner configured to scan the product;
a payment processing unit, the payment processing unit configured to detect a payment source;
a battery configured to power the user interface and the payment processing unit; and
a power source comprising a plug compatible with an electrical outlet, the power source configured to power the cooling system and recharge the battery when the plug is inserted into the electrical outlet; and
a control unit configured to:
communicate with the payment processing unit to authorize a purchase of the product when the payment processing unit detects a payment source; and
activate the cooling system when the mobile vending system is coupled to a power supply and based on the detection of the temperature sensor; and
wherein the mobile vending system is movable from a first position to a second position.

2. The system of claim 1, further comprising a housing disposed on an exterior of the mobile vending system, the housing comprising the user interface, scanner, the payment processing unit, and the control unit.

3. The system of claim 1, further comprising a second battery,
wherein the power source is configured to recharge the second battery when the plug is inserted into the electrical outlet; and
wherein the battery is configured to power the cooling system when the power source is not inserted into the electrical outlet and when the temperature sensor detects that the temperature of the storage compartment is greater than the predetermined temperature.

4. The system of claim 3, further comprising a photovoltaic panel configured to charge the second battery when the power source is not inserted into the electrical outlet.

5. The system of claim 1, further comprising wheels configured to roll the mobile vending system from a first position to a second position.

6. The system of claim 1, wherein the storage compartment comprises one or more drawers.

7. The system of claim 1, wherein the storage compartment comprises a door for sealing the storage compartment.

8. The system of claim 1, further comprising a lock configured to lock the storage compartment, wherein the control unit is configured to unlock the lock when the control unit authorizes the purchase.

9. The system of claim 1, wherein the payment processing unit comprises one or more of a credit card reader, a near field communication antenna, and a chip reader.

10. The system of claim 1, wherein the display is a touch-screen display configured to receive a user input.

11. The system of claim 1, wherein the storage compartment comprises and inventory management system configured to detect addition or removal of products.

12. The system of claim 11, wherein the inventory management system comprises at least one camera configured to detect when a product is added or removed from the storage compartment.

13. The system of claim 11, wherein the inventory management system comprises weight sensors configured to detect when a product has been removed.

14. A mobile vending system, the system comprising:
a storage compartment configured to store pre-chilled products, the storage compartment being insulated;
temperature control packs removably disposed within the storage compartment;
a user interface, the user interface comprising a display;
a payment processing unit, the payment processing unit configured to detect a payment source;
a control unit configured to communicate with the payment processing system to authorize a purchase of the at least one of the product when the payment processing unit detects a payment source;
a battery configured to provide power to the user interface, the payment processing unit, and the control unit; and
a housing disposed on an exterior of the mobile vending system, the housing comprising the user interface, the payment processing unit, and the control unit;
wherein the mobile vending system is movable from a first position to a second position.

15. The system of claim 14, further comprising a temperature sensor disposed within the storage compartment, the temperature sensor configured to detect the temperature within the storage compartment.

16. The system of claim 15, wherein the system is configured to notify a remote user when the temperature sensor detects that the temperature is above a predetermined threshold for a first period of time.

17. The system of claim 14, wherein the temperature control packs comprise one or more of a freezable gel or ice.

18. The system of claim 14, further comprising a lock configured to lock the storage compartment.

19. The system of claim 18, wherein the control unit is configured to unlock the lock when the control unit authorizes the purchase.

20. The system of claim 19, wherein the control unit is configured to re-lock the lock after a predetermined delay.

21. The system of claim 14, wherein the system is configured to provide an audible alert if the storage compartment is open for more than a second period of time.

22. The system of claim 14, wherein the products comprise one or more of a beverage or a food product.
